(19) United States
(12) Patent Application Publication
(10) Pub. No.: US 2016/0042362 A1
(43) Pub. Date: Feb. 11, 2016

(54) RECORDING PURCHASE BEHAVIOR USING DEVICE WITH MULTIPLE FEEDBACK AND INPUT MODALITIES

(71) Applicant: Google Inc., Mountain View, CA (US)

(72) Inventor: Simon Michael Rowe, Berkshire (GB)

(73) Assignee: Google Inc., Mountain View, CA (US)

(21) Appl. No.: 14/072,309

(22) Filed: Nov. 5, 2013

(51) Int. Cl. G06Q 30/02

(52) U.S. Cl. CPC G06Q 30/0201

(57) ABSTRACT

A method for recording product purchase behavior includes receiving, at a processor, primary product data read by a local media device from a data element associated with a product to be purchased; comparing, by the processor, the primary product data to stored product data to identify the product to be purchased; sending, by the processor, a feedback signal to the local media device; in response to the feedback signal, receiving, by the processor, secondary product data from the local media device; and storing the primary product data with the secondary product data.

### BACKGROUND

Panels may be recruited to record various behaviors of a population sample. These behaviors include television program viewing and product purchases, for example. The sample data then may be used to estimate corresponding behaviors of the population. Ideally, the activities and actions of a recruited panelist would be followed from a first advertisement exposure to a purchase of a corresponding product.

Such advertisement exposure may be recorded manually by the panelist, or electronically by a meter coupled to a media device on which the advertisement is served. Purchase actions also may be recorded manually by the panelist. The panelist also may use a scanning device such as a barcode scanner to record the purchase actions.

### SUMMARY

A method for recording product purchase behavior includes receiving, at a processor, primary product data read by a local media device from a data element associated with a product to be purchased; comparing, by the processor, the primary product data to stored product data to identify the product to be purchased; sending, by the processor, a feedback signal to the local media device; in response to the feedback signal, receiving, by the processor, secondary product data from the local media device; and storing the primary product data with the secondary product data.

A product purchase data system includes a computer readable storage medium comprising instructions for acquiring and processing product data from a product, sending the product data to a remote service, and receiving a feedback signal from the remote service; and a processor. The processor executes the instructions to receive primary product purchase data, process the received primary product purchase data, send the processed, received primary product purchase data to a remote device, receive a feedback signal from the remote device indicative of the primary product purchase data, and receives, process, and send to the remote device, secondary product purchase data.

A method, implemented by a processor, for acquiring and processing product purchase data for purchase of a product includes receiving, by the processor, primary product purchase data, the primary product purchase data uniquely identifying the product; sending, by the processor, the primary product purchase data to a remote server; receiving, by the processor, a feedback signal from the remote server based on the primary product purchase data; and sending, by the processor, secondary product purchase data to the remote server.

A system for recording product purchase data associated with a purchase of a product includes an image capture device that reads primary product data from a data element associated with the product; a transmit/receive device that sends an output file containing the read primary product data to a remote processor and receives in return a primary product data feedback signal; a display that displays the primary product data feedback signal, the primary product data feedback signal indicating additional product data acquisition is needed; and a secondary data input mechanism that acquires secondary product data, wherein the transmit/receive device sends the secondary product data to the remote processor.

### DESCRIPTION OF THE DRAWINGS

The detailed description refers to the following figures in which like numerals refer to like items, and in which:

FIG. 1 illustrates an example environment in which product purchase behavior may be recorded and analyzed;

FIGS. 2A and 2B illustrate an example client-side product purchase system for use by a purchase panelist;

FIGS. 3A and 3B illustrate an example server-side product purchase system; and

FIGS. 4 and 5 are flow charts illustrating example product purchase data methods.

### DETAILED DESCRIPTION

Panels may be recruited to record various behaviors of a population sample. The sample data then may be used to estimate corresponding behaviors of the population. Ideally, the activities and actions of a recruited panelist would be followed from a first advertisement exposure to a purchase of a corresponding product.

Following a recruited panelist from ad exposure to product purchase may be important both for traditional advertisers and brand advertisers. A large recruited panel in which online ad exposure can be controlled makes it possible to run experiments where some proportion of the panel is exposed to an advertiser's ads, and the rest have them suppressed. By being able to track both sets of a panelist purchases, it is possible to determine the effectiveness of the advertising.

Traditional purchase panels either require a user to type in their purchases, or else supply them with a scanner to scan their applications. Typically this scanner is a standalone barcode scanner. Other alternatives are applications which run on a mobile phone or personal computer and use the camera on the phone to take a picture of a product or product receipt.

Such advertisement exposure may be recorded manually by the panelist, or electronically by a meter coupled to a media device on which the advertisement is served. Purchase actions also may be recorded manually by the panelist. The panelist may use a standalone scanning device such as a barcode scanner to record the purchase actions. Such scanning devices may include audio recording features that allow the panelist to provide voice annotations with a scanning action. The scanned data may be provided to a product purchase system. The product purchase system may include a product barcode database and a mechanism for comparing scanned barcodes to the product barcode database.

One problem with these processes for capturing product purchase data is that the processes do not provide the panelist with feedback to tell the panelist that the product has been identified. Another problem is that a product purchase system and associated process may need a robust database of product barcodes in order to operate efficiently. However, product manufacturers may not release the barcode data for this purpose.

To overcome these and other problems with current product purchase panel systems, disclosed herein are systems and corresponding methods that combine barcode scanning and visual/audio features to produce and support use of a product purchase device that provides barcode scanning capabilities, or similar primary product identification features, with real-time feedback and subsequent voice or text annotation, or other secondary product identification features, to record a product purchase action by a recruited panelist. In an embodiment, a local media device such as a purchase scanner combines a barcode scanner as one input modality for primary data acquisition, a feedback mechanism, and an additional input modality such as voice recognition, image capture, or text entry for secondary data acquisition.

The systems also include a product purchase system. Elements of the product purchase system may be implemented on the client side and the server side of a client-server architecture. When a panelist scans a product barcode, the scanned data (i.e., the barcode) may be transmitted to a remote server such as an Internet server. In an embodiment, the transmission is in real time. This server executes instructions that compare the barcode to a dictionary or database of known barcodes. If the barcode is found in the database, the server responds with a barcode found signal, which is returned in real time to the scanner. The scanner then provides the panelist with a positive feedback signal (e.g., a happy beep). If however the product barcode is not found in the database, the server responds with a not found signal, which is returned in real time to the scanner. The scanner then provides the panelist with a negative feedback signal (e.g., a sad beep). The panelist then has the option to trigger the additional input modality (e.g., voice recognition), and say the name of the product. The audio from this input modality then is transmitted to the server where speech recognition decodes the audio and associates the product name with the previously transmitted barcode. In an aspect, the scanner may prompt the panelist for more detail about the product such as brand, name, and size (where appropriate) and other information needed to distinguish the product from other products. One aspect of this data collection by the product purchase system may be to develop, over time, a more complete product barcode database to better identify product purchases. Another aspect of the data collection is a verification process where entries in the product barcode database are verified by comparing additional modality entries to the same barcode to ensure consistent and accurate product definitions.

As noted above, other alternate input modalities include a text entry mechanism and an image capture mechanism. For example, a panelist could take a picture of the product or could type in the product title, brand, size, and other data into a free form text entry window or into a pre-formatted text entry window.

As an alternative to using a dedicated scanner with multiple input modalities, the panelist may use a portable media device such as a smart phone or tablet. The media device may include image capture (e.g., a camera) and audio capture (e.g., a microphone) mechanisms in conjunction with programming or applications to allow the media device to perform the operations noted above with respect to the standalone scanner.

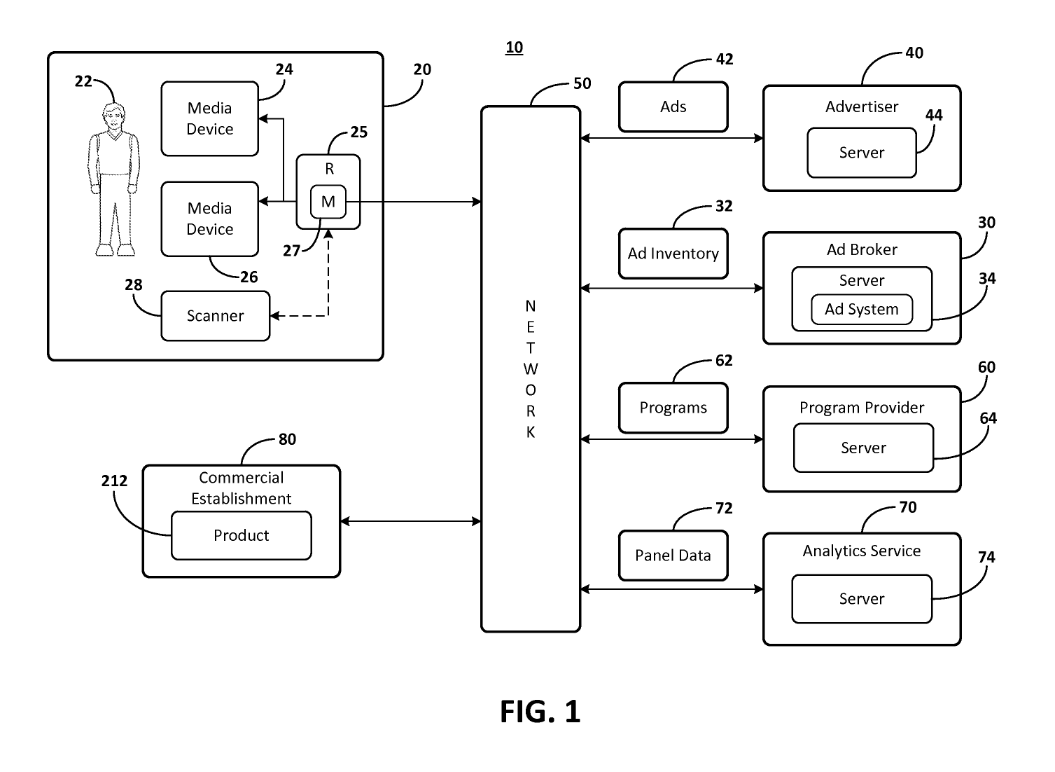

FIG. 1 illustrates an example environment in which purchase behavior may be recorded and analyzed. In FIG. 1, environment 10 includes viewing location 20, ad broker 30, advertiser 40, program provider 60, and analytics service 70, all of which communicate over network 50. Also shown in FIG. 1 is commercial establishment 80 at which a panelist may purchase goods and services.

The viewing location 20 may include first media device 24 and second media device 26 through which panelist 22 receives advertisements 42 from advertiser 40 and programs 62 (e.g., videos) from program provider 60. A viewing location 20 may be the residence of a panelist 22 who operates media devices 24 and 26 to access, through router 25, resources such as Web sites and to receive television programs, radio programs, and other media. The media devices 24 and 26 may be fixed or mobile. For example, media device 24 may be an Internet connected smart television (iTV); a basic or smart television connected to a set top box (STB) or other Internet-enabled device; a Blu-ray™ player; a game box; and a radio, for example. Media device 26 may be a tablet, a smart phone, a laptop computer, or a desk top computer, for example. The media devices 24 and 26 may include browsers (not shown). The browser may be a software application for retrieving, presenting, and traversing resources such as at the Web sites. The browser may record certain data related to the Web site visits. The media devices 24 and 26 also may include applications. The panelist 22 may cause the media devices 24 or 26 to execute an application, such as a mobile banking application, to access online banking services. The application may involve use of a browser or other means, including cellular means, to connect to the online banking services.

The viewing location 20 may include a meter 27 that records and reports data collected during exposure of advertisements 42 and programs 62 to the panelist 22. The example meter 27 may be incorporated into the router 25 through which all media received at the viewing location 20 passes. Alternately, the panelist 22 may operate separate meters (not shown) for each media device. The meter 27 may send the collected data to the analytics service 70.

Also shown at the viewing location 20 is standalone scanner 28. The scanner 28 may be used to obtain and transmit data from products and services provided and purchased at the commercial entity 80. Operation of the scanner 28 is described below.

The determination of which advertisements 42 to serve with which program 62 may depend in part on information related to the panelist 22 at the viewing location 20. This information may be provided by the panelist 22 voluntarily. For example, a panelist 22 may register with the advertiser 40 or otherwise agree to serve as a panelist and may provide information such as a password and user ID. In situations in which the systems disclosed herein collect personal information about the panelist 22, or may make use of personal information, the panelist 22 may be provided with an opportunity to control whether programs or features collect panelist information (e.g., information about a panelist's social network, social actions or activities, profession, a panelist's preferences, or a panelist's current location), or to control whether and/or how to receive sponsored content segments that may be more relevant or of interest to the panelist 22. In addition, certain data may be treated in one or more ways before it is stored or used, so that personally identifiable information is removed. For example, a panelist's identity may be treated so that no personally identifiable information can be determined for the panelist 22, or a panelist's geographic location may be generalized where location information is obtained (such as to a city, ZIP code, or state level), so that a particular location of a panelist 22 cannot be determined. Thus, the panelist 22 may have control over how information is collected about the panelist 22 and used by a server.

The ad broker 30 provides an advertisement service, executed as an advertisement system on server 34. The ad broker 34 sell ad inventory 32 to advertiser 40. The ad inventory 32 may appear in the programs 62.

The advertiser 40 operates ad server 44 to provide advertisements that may be served with programs 62 provided by the program provider 60. For example, the server 44 may provide advertisements to serve at Internet Web pages, in applications executing on the media devices 24 and 26, and in breaks in broadcast television programs. The advertiser 40 may represent a single company or entity, or a group of related companies.

The network 50 may be any communications network that allows the transmission of signals, media, messages, voice, and data among the entities shown in FIG. 1, including radio, linear broadcast (over-the-air, cable, and satellite) television, on-demand channels, over-the-top media, including streaming video, movies, video clips, and games, and text, email, and still images, and transmission of signals, media, messages, voice, and data from a media device to another media device, computer, or server. The network 50 includes the Internet, cellular systems, and other current and future mechanisms for transmission of these and other media. The network 50 may be both wired and wireless.

The program provider 60 operates server 64 to deliver programs 62 for consumption by the panelist 22. The programs 62 may be broadcast television programs, radio programs, Internet Web sites, or other media. The programs 62 include provisions for serving and displaying advertisements 42; that is, the programs 62 include ad inventory 32. The program provider 60 may receive the advertisements 42 from the advertiser 40 and incorporate the sponsored content segments into the programs 62. Alternately, the panelist's media devices may request an advertisement 42 when those media devices display a program 62.

The analytics service 70, which operates analytics server 74, may collect data related to advertisements 42 and programs 62 to which a panelist 22 was exposed. In addition, the analytics service 70 may obtain product and service acquisition or purchase data. The data may be obtained by the panelist 22 operating the standalone scanner 28. In an embodiment, such data collection is performed through a panelist program where panelists 22 are recruited to voluntarily provide such data. The actual data collection may be performed by way of surveys and/or by collection by the meters 27 in addition to the data collected by the scanner 28. The collected data are sent to, processed by, and stored in analytics server 74, which then processes the data.

Commercial establishment 80 may be a brick and mortar building in which a panelist 22 may purchase goods and services (i.e., products 212). For example, the commercial establishment may be a grocery store, and the panelist 22 may purchase various food products from the store 80. Food product packaging typically includes a data element such as a barcode, which the panelist 22 may scan when making a purchase.

However, the panelist 22 also may scan barcodes of products purchased through other channels. For example, the panelist 22 may see a product in a magazine advertisement. The advertisement may include a barcode. The panelist 22 may scan the barcode to actually purchase the product; the panelist 22 also may scan the barcode as part of the product purchase panel process.

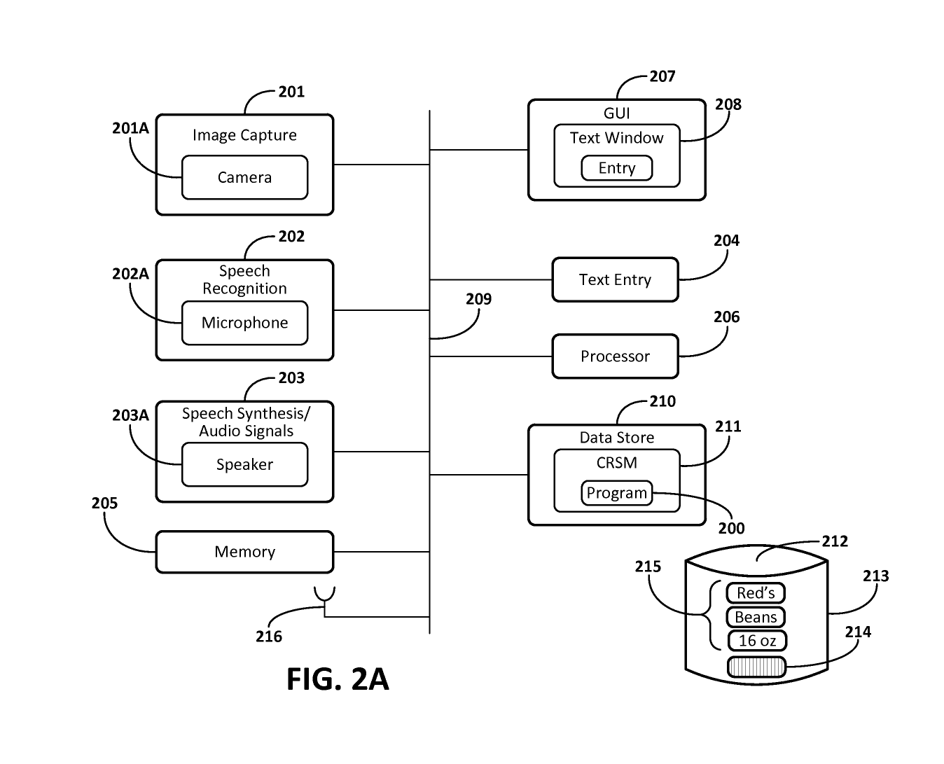

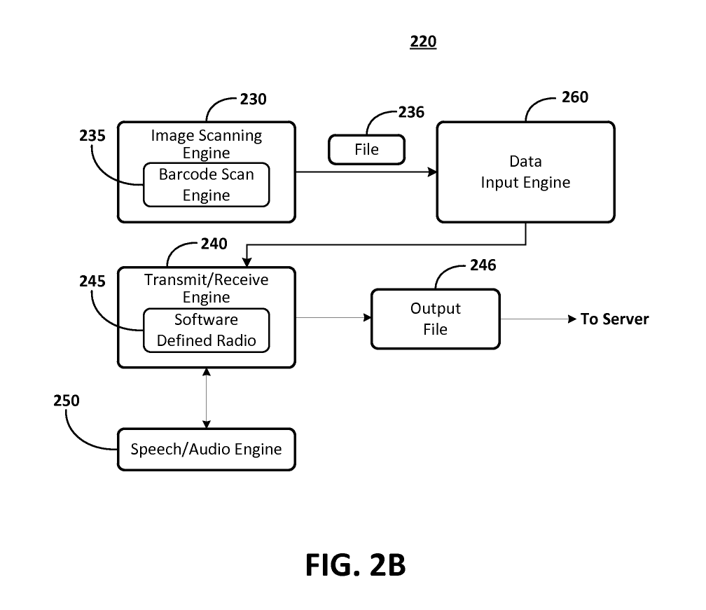

FIGS. 2A and 2B illustrate an example client-side product purchase system for use by a purchase panelist. The system 200 may be implemented in whole or in part in the scanner 28. Alternately, scanner functions may be incorporated in mobile media device 26.

In FIG. 2A, system 200 includes image capture device 201, speech recognition device 202, speech/audio synthesis device 203, text entry device 204, memory 205, processor 206, graphical user interface (GUI) 207, including text entry window 208, communications bus 209 linking the above devices, data store 210, and transmit/receive antenna 216. The above noted devices may be implemented in hardware.

The data store 210 may include a non-transitory computer-readable medium 211 on which reside product purchase program 220. The program 220 is described elsewhere herein including with respect to FIG. 2B.

Also shown in FIG. 2A is an example of a product 212. The product 212 is contained in package 213. The package 213 includes a data element, which in an embodiment is a barcode 214, and product descriptive information 215. The example product 212 is a quantity of beans and the package 213 is a can with a paper wrapper on which are printed the barcode 214 and the product descriptive material 215, which may include a brand name, a product name, and a product quantity. The barcode 214 may be a one-dimensional barcode or a two-dimensional barcode. The barcode 214 may have associated a text field (not shown) in which are inserted numerals corresponding to the barcode 214. The barcode 214 also may include a watermark not visible to the panelist 22 and that would not be rendered visible when the barcode 214 is rendered. However, when the barcode 214 is scanned, data defining the watermark are included in a scan file resulting from the scanning.

In an alternate embodiment, the data element associated with or affixed to product 212 may be a passive RFID tag, and the system 200 may be configured to read data from the RFID tag. Other data elements also could be used in place of the barcode 214.

Products other than product 212 (i.e., other than a can of beans) may be subjected to processing by the system 200. For example, the same can of beans could be advertised in a magazine. The system 200 could scan a barcode provided with the advertisement to order the can of beans over the Internet. The same scanning operation may provide the barcode data to server 74. This same scanning operation would include the same feedback mechanisms as are available when scanning a physical can of beans in a grocery store. Thus, the herein disclosed systems may be used to collect product purchase data in virtually any scenario and over virtually any channel.

Image capture device 201 may include a camera 201A that is capable of supporting barcode scanning and image capture of the barcode 214 and image capture of the entire package including the product descriptive material 215.

Speech recognition device 202 includes a microphone 202A that is capable of receiving speech from the panelist 22, and audio signals.

Speech/audio synthesis device 203 includes a speaker 203A through which sounds and synthesized voice may be provided.

Text entry device 204 may be a keyboard implemented as a soft keyboard (i.e., as a GUI) or a hard keyboard (i.e., buttons), and other text entry components such as a pointing device.

Memory 205 holds instructions for execution by processor 206.

Processor 206 executes instructions of program 220 to record and report panelist purchase behavior and to provide feedback to the panelist 22.

Graphical user interface (GUI) 207, in addition to displaying a soft keyboard, provides text entry window 208 and associated control features. The text entry window 208 may display a pre-formatted text entry form, pull down menus, and other components that allow the panelist 22 to quickly, efficiently, and accurately enter secondary product data related to product 212.

The transmit/receive antenna 216 sends signals and data to a remote server and receives signals back from the remote server.

Communications bus 209 links the above devices to allow signals and data to pass among the devices.

FIG. 2B illustrates example components of product purchase program 220. The components may include modules having machine instructions executed by processor 206. Certain of the components may interact with the hardware devices shown in FIG. 2A.

The program 220 includes image scan engine 230, transmit/receive engine 240, speech/audio engine 250, and data input engine 260. The image scan engine 230 operates with the camera 201A of image capture device 201 to capture images of product 212. The camera 201A works in a conventional sense to capture product data 215, when an alternate modality is used to identify product 212. Thus, the image scan engine 230 generates a digital scan file 236 representing the product descriptive material 215.

In an embodiment, the engine 230 includes barcode scan engine 235. The barcode scan engine 240 operates to read barcode 214. The scanned data, in the form of the scan file 236 then may be passed to data input engine 260. The image scan engine 230 also may provide a rendering of the barcode 214 to the data input engine 260.

As noted above, the barcode 214 may include a watermark. When the barcode 214 is scanned, the watermark is read by the engine 230 and its data are included in the scan file 236.

Transmit/receive engine 240 provides for communication outside the media device hosting the system 200. The engine 240 includes software defined radio (SDR) 245. Software defined radios are well known in the art, and in general, SDR 245 does not require further explanation herein. Other data communications mechanisms may be used in place of the SDR 245. The transmit/receive engine 240 sends digitized data (e.g., from barcode 214) in the form of output file 246 to and receives digitized data from analytics server 74.

Speech/audio engine 250 works with speech recognition device 202 and speech synthesis/audio signal device 203 to convert analog signals to digital signals and digital signals to analog signals. The engine 250 also may convert digital files to text or image files for display to the panelist 22 on GUI 207.

Data input engine 260 provides any further processing of data collected through a scanning process or through a manual data entry process. In addition, the engine 260 may include a checking feature that compares data from a current data scanning process to data from prior data scanning processes to ensure consistency of data input.

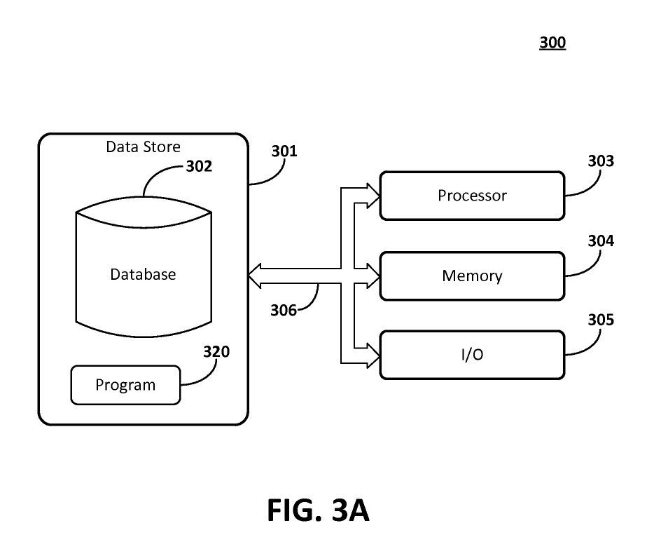

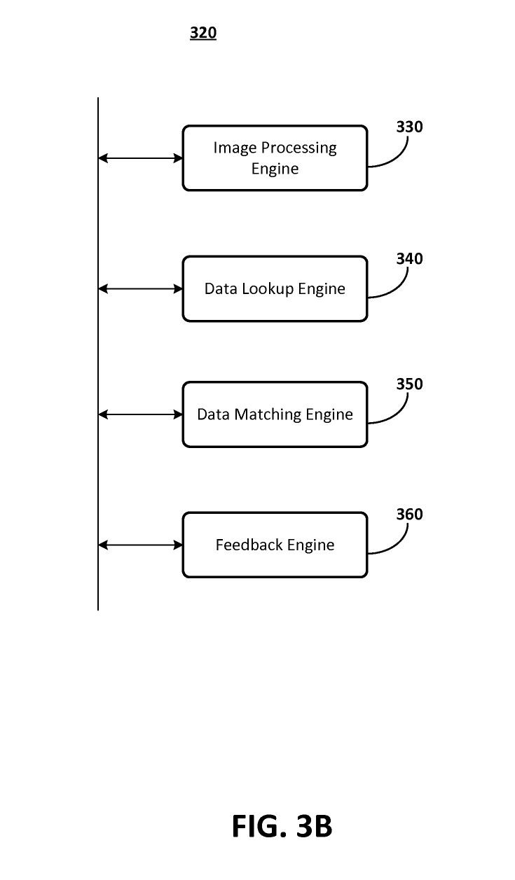

FIGS. 3A and 3B illustrate an example server-side product purchase system. In an embodiment, server-side product purchase system 300 is implemented on server 74.

In FIG. 3A, the system 300 includes data store 301, processor 303, memory 304, and input/output (I/O) 305. These components are linked by communications bus 306.

The data store 301 includes database 302 and product purchase program 320, which is described elsewhere herein, including with reference to FIG. 3B.

The database 302 stores, among other data product description/barcode data that allows components of the system 300 to identify, using a first modality, a purchased product based on a scanned barcode.

The processor 303 reads instructions of program 320 into memory 304 and executes the instructions.

The I/O 305 allows machine and human interaction with the system 300.

The bus 306 provides for signaling and data transfer among components of the system 300.

FIG. 3B illustrates an example of product purchase program 320. The program 320 receives product purchase data primarily from panelists such as panelist 22, and provides feedback to the panelists.

The program 320 includes image processing engine 330, data lookup engine 340, data matching engine 350, and feedback engine 360. The image processing engine 330 receives digital files 246 corresponding to scanned barcodes contained on products 212 and image data 215 for certain products 212 when a barcode is not recognized in the database 302. The image processing engine 330 may pass the barcode data to the data lookup engine 340. When the incoming data 246 includes, for example, a digital photo of product 212, the engine 330 may extract data from the image, such as product brand, name, and size. When the incoming data includes a text transmission with text data entered with an alternative modality, the engine 330 may extract data, such as brand, name, and size, from data fields provided in the text transmission.

Data lookup engine 340 compares the received barcode 214 to data in the database 302 to determine if the barcode 214 exists in the database 302. If a match is found, the engine 340 extracts relevant product data from the stored barcode entry. For example, a stored barcode entry may include product brand, product name, and product size. The engine 340 passes the barcode 214 and, where appropriate, the existence of a match and the associated product data, to data matching engine 350. The engine 340 also signals the feedback engine 360 that a match was found in the database 302.

If a match is not found, the engine 340 may so signal the feedback engine 360. The engine 340 may create an entry in the database 302 for the new barcode.

Data matching engine 350 verifies that the received barcode corresponds to products that currently are part of a product purchase campaign. For example, a two-week product purchase campaign may be designed to collect product purchase data for non-perishable (as opposed to fresh) food products. Should a panelist 22 provide barcode data for a non-food item, the engine 350 may note the discrepancy. However, the engine 350 may store the barcode data with the product description in the database 302. At the conclusion of a product purchase process, the engine 350 may store all appropriate data in the database 302.

The feedback engine 360 provides a negative feedback signal to the system 200 when a match is not found in the database 302. When alternate modalities are used to send product purchase data to the system 300, the feedback engine 360 may signal the system 200 when the alternately-delivered data are sufficient to identify the associated product.

In an embodiment, the engine 360 provides a positive feedback signal to the system 200 when the received barcode matches an entry in the database 302. Alternately, only negative feedback signals are provided.

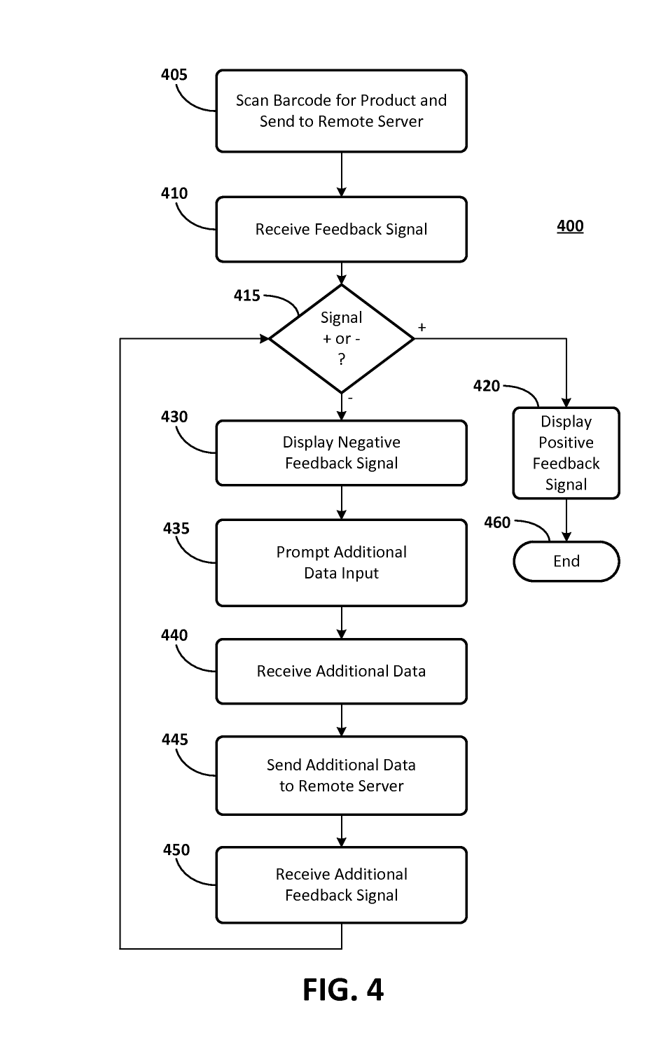

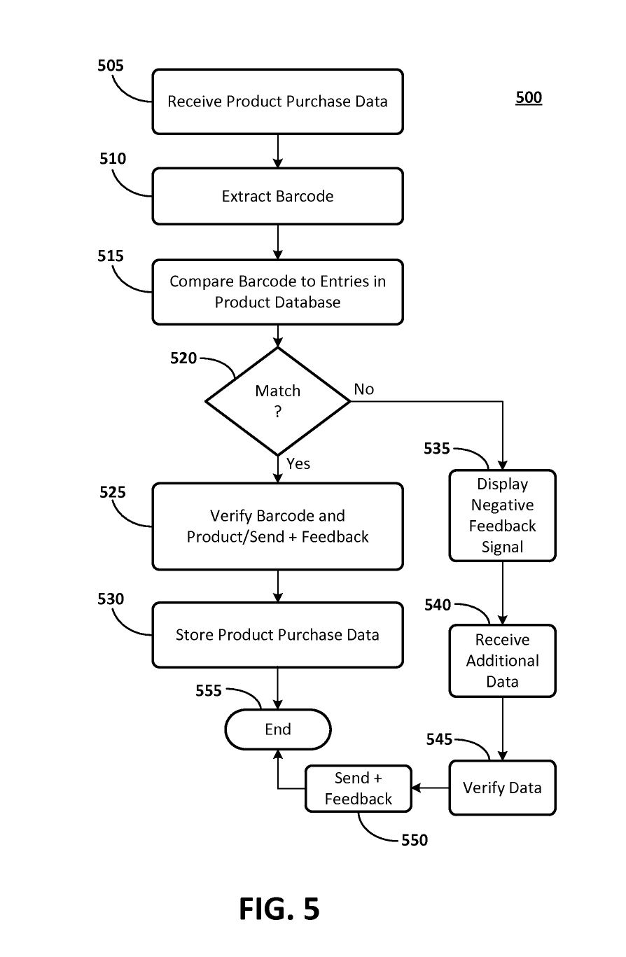

FIGS. 4 and 5 are flow charts illustrating example product purchase data collection methods. The methods of the flow charts are described with respect to the systems, devices, and entities of FIGS. 1-3B. The methods further assume that panelists, such as panelist 22, have been instructed to provide product purchase data for a specific product or class of products purchased though one or more specified avenues or network. For example, a product purchase campaign may be defined as a two-week period in which panelists record product purchase data for non-perishable food products.

In FIG. 4, client-side product purchase method 400 begins in block 405 when panelist 22 scans barcode 214 for product 212. The scanned data are processed by system 200 and are sent in a file to system 300 on server 74. In block 410, the system 200 receives a feedback signal from the system 300. In block 415, the system 200 determines if the feedback signal is positive or negative. In block 415, if the feedback signal is determined to be positive, the method 400 moves to block 425, and the system 200 plays or displays the positive feedback signal. The method 400 then moves to block 460 and ends.

Returning to block 415, if the system 200 determines the feedback signal is negative, the method 400 moves to block 430 and plays or displays the negative feedback signal. Next, in block 435, the system 200 prompts the panelist 22 to use an alternate modality to enter product data. For example, the system 200 may display a pre-formatted text entry screen in GUI 207 that has provisions for product brand, name, and size. Other alternate modalities, noted above, may be used.

In block 440, the system 400 receives the additional data from the panelist 22, and, as necessary, processes the data. In block 445, the system 200 sends the additional data to the system 300. In block 450, the system 200 may receive an additional feedback signal from the system 300. The method 400 then returns to block 415, and the system 200 determines if the additional feedback signal is positive or negative. If the additional feedback signal is a positive signal, the method 400 returns to block 420. If the additional feedback signal is negative, the method 400 returns to block 430. This additional data collection process of blocks 430-450 may continue for a defined number of cycles. In an embodiment, the additional feedback signal may indicate specific product purchase data to enter, or that the system 300 determines is erroneous. In block 460, the method 400 ends.

In FIG. 5, server-side product purchase method 500 begins in block 505 when the system 300 receives product purchase data for product 212 from panelist 22. In block 510, the system 300 extracts the barcode data associated with the purchased product 212. In block 515, the system 300 compares the barcode data to entries in database 302 and in block 520 determines if a match exists. If, in block 520, a match is found, the method 500 moves to block 525 and the system 300 verifies the barcode corresponds to product purchases being monitored as part of the current product purchase campaign. The system 300, in block 530, stores the product purchase data as part of the two-week product purchase campaign and optionally sends a positive feedback signal to the system 200. The method 500 then moves to block 555 and ends.

In block 515, if a match is not found, the method 500 moves to block 535 and the system 300 sends a negative feedback signal to the system 200. In block 540, the system 300 receives additional product purchase data from the system 200. The additional product purchase data may include brand name, product name, and size, for example. In block 545, the system 300 verifies the additional product purchase information is correct, that the product purchased corresponds to products being monitored as part of the current product purchase campaign, and saves the barcode and associated product data in database 302. The method 500 moves to block 550, and the system 300 sends a positive feedback signal to the system 200. Following block 550, the method 500 moves to block 555 and ends.

In the preceding discussion, product purchase processes are described with respect to collecting barcode data associated with a purchased product. As noted above, the barcode need not be affixed to the product or the product packaging, such as might be the situation where a product being purchased is advertised or offered in hard copy or electronic format along with a barcode as part of the advertisement or offer. Thus, a product purchase campaign may be designed to identify products purchased through a magazine, for example. In such a campaign, the barcode may include data identifying the location of the product (here, in a magazine) being purchased. The barcode thus provided may correspond in all respect to a barcode provided on a package for the product, with the exception of having additional location data included. One mechanism for including the location data may be a watermark that encodes the location.

In an embodiment, the product purchase processes use a barcode to identify a product being purchased. However, data elements other than barcodes may be used. For example, a product package may include a passive radio frequency identification (RFID) tag, a watermark, or hologram that encodes product data. Thus, the systems and methods disclosed herein may use any data element having embedded or encoded product data to identify a product being purchased so long as those data can be perceived and recorded by a properly programmed device.

Certain of the devices shown in FIGS. 1, 2A and 3A include a computing system. The computing system includes a processor (CPU) and a system bus that couples various system components including a system memory such as read only memory (ROM) and random access memory (RAM), to the processor. Other system memory may be available for use as well. The computing system may include more than one processor or a group or cluster of computing system networked together to provide greater processing capability. The system bus may be any of several types of bus structures including a memory bus or memory controller, a peripheral bus, and a local bus using any of a variety of bus architectures. A basic input/output (BIOS) stored in the ROM or the like, may provide basic routines that help to transfer information between elements within the computing system, such as during start-up. The computing system further includes data stores, which maintain a database according to known database management systems. The data stores may be embodied in many forms, such as a hard disk drive, a magnetic disk drive, an optical disk drive, tape drive, or another type of computer readable media which can store data that are accessible by the processor, such as magnetic cassettes, flash memory cards, digital versatile disks, cartridges, random access memories (RAM) and, read only memory (ROM). The data stores may be connected to the system bus by a drive interface. The data stores provide nonvolatile storage of computer readable instructions, data structures, program modules and other data for the computing system.

To enable human (and in some instances, machine) user interaction, the computing system may include an input device, such as a microphone for speech and audio, a touch sensitive screen for gesture or graphical input, keyboard, mouse, motion input, and so forth. An output device can include one or more of a number of output mechanisms. In some instances, multimodal systems enable a user to provide multiple types of input to communicate with the computing system. A communications interface generally enables the computing device system to communicate with one or more other computing devices using various communication and network protocols.

The preceding disclosure refers to flow charts and accompanying description to illustrate the embodiments represented in FIGS. 4 and 5. The disclosed devices, components, and systems contemplate using or implementing any suitable technique for performing the steps illustrated. Thus, FIGS. 4 and 5 are for illustration purposes only and the described or similar steps may be performed at any appropriate time, including concurrently, individually, or in combination. In addition, many of the steps in the flow charts may take place simultaneously and/or in different orders than as shown and described. Moreover, the disclosed systems may use processes and methods with additional, fewer, and/or different steps.

Embodiments disclosed herein can be implemented in digital electronic circuitry, or in computer software, firmware, or hardware, including the herein disclosed structures and their equivalents. Some embodiments can be implemented as one or more computer programs, i.e., one or more modules of computer program instructions, encoded on computer storage medium for execution by one or more processors. A computer storage medium can be, or can be included in, a computer-readable storage device, a computer-readable storage substrate, or a random or serial access memory. The computer storage medium can also be, or can be included in, one or more separate physical components or media such as multiple CDs, disks, or other storage devices. The computer readable storage medium does not include a transitory signal.

The herein disclosed methods can be implemented as operations performed by a processor on data stored on one or more computer-readable storage devices or received from other sources.

A computer program (also known as a program, module, engine, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

I claim:

1. A method, implemented by a processor, for acquiring and processing product purchase data for purchase of a product, comprising:
receiving, by the processor, primary product purchase data, the primary product purchase data uniquely identifying the product;
sending, by the processor, the primary product purchase data to a remote server;
receiving, by the processor, a feedback signal from the remote server based on the primary product purchase data; and
sending, by the processor in response to the feedback signal, secondary product purchase data to the remote server.

2. The method of claim 1, further comprising receiving a positive feedback signal from the remote server based on the secondary product purchase data.

3. The method of claim 1, wherein the primary product purchase data are barcode data obtained from a barcode associated with the product, the method further comprising scanning the barcode using a scanning device coupled to the processor.

4. The method of claim 3, further comprising presenting the feedback signal to a panelist.

5. The method of claim 4, further comprising providing a prompt to the panelist to provide the secondary product purchase data.

6. The method of claim 5, wherein the secondary product purchase data are provided by one of a text entry, a voice entry, and a product image capture.

7. The method of claim 3, wherein the barcode is affixed to the product.

8. The method of claim 3, wherein the barcode is not affixed to the product.

9. The method of claim 1, further comprising performing the sending and receiving in real time relative to the purchase of the product.

10. A system for recording product purchase data associated with a purchase of a product, comprising:
an image capture device that reads primary product data from a data element associated with the product;
a transmit/receive device that sends an output file containing the read primary product data to a remote processor and receives in return a primary product data feedback signal;
a display that displays the primary product data feedback signal, the primary product data feedback signal indicating additional product data acquisition is needed; and
a secondary data input mechanism that acquires secondary product data, wherein the transmit/receive device sends the secondary product data to the remote processor.

11. The system of claim 10, wherein the primary product data are encoded into the barcode, and wherein the image capture device comprises:
a camera;
processing instructions stored on a computer readable storage medium; and
a processor coupled to the camera, the processor executing the instructions to read the primary product data encoded into the barcode and to produce the output file for transmission to the remote server.

12. The system of claim 10, wherein the display device comprises a speaker and the feedback signal is an audio signal.

13. The system of claim 10, wherein the display device comprises a visual display and the feedback signal is a visual signal.

14. The system of claim 10, wherein the secondary data input mechanism comprises:
a microphone;
processing instructions stored on a computer readable storage medium; and
a processor coupled to the microphone, the processor executing the instructions to receive an audio input and to convert the audio input into a digital audio output file comprising digitized secondary product data.

15. A product purchase data system, comprising:
a computer readable storage medium comprising instructions for acquiring and processing product data from a product, sending the product data to a remote service, and receiving a feedback signal from the remote service; and
a processor that executes the instructions to:
receive primary product purchase data,
process the received primary product purchase data,
send the processed, received primary product purchase data to a remote device,
receive a feedback signal from the remote device indicative of the primary product purchase data, and
receive, process, and send to the remote device, secondary product purchase data.

16. The system of claim 15, wherein the processor processes the primary product purchase data read by from a barcode associated with the product by an image capture device coupled to the system, and processes the secondary product purchase data received from a manual entry device coupled to the system.

17. A method for recording product purchase behavior, comprising:
receiving, at a processor, primary product data read by a local media device from a data element associated with a product to be purchased;
comparing, by the processor, the primary product data to stored product data to identify the product to be purchased;
sending, by the processor, a feedback signal to the local media device;
in response to the feedback signal, receiving, by the processor, secondary product data from the local media device; and
storing the primary product data with the secondary product data.

18. The method of claim 17, wherein sending the feedback signal comprises sending a negative feedback signal indicative of a non-matching comparison.

19. The method of claim 17, further comprising validating the primary product data and the secondary product data related to an actual product.

20. The method of claim 19, further comprising sending a positive feedback signal to the local media device upon completing the data validation.
